(19) United States
(12) Patent Application Publication
(10) Pub. No.: US 2004/0075189 A1
(43) Pub. Date: Apr. 22, 2004

(54) Method for making dual-color melamine container

(76) Inventor: Ching-Lin Tai, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/270,612

(22) Filed: Oct. 16, 2002

(51) Int. Cl. B29C 45/16

(52) U.S. Cl. 264/245; 264/255; 264/328.8

(57) ABSTRACT

A method for making a dual-color melamine container includes (1) making an inner part of container with a first mold by injection molding; the male part of the first mold being formed with several projecting patterns thereon so that the inner part of container is formed with holes having patterns, (2) attaching patterns to an inner side of the inner part of container, and (3) repositioning the inner part in a second mold, and forming an outer part of container over the inner container part, and attaching patterns to an outer side of the outer container part; thus, the inner part can be made dial-color with injection molding if melamine materials used in both injection molding processes are different colors.

### BACKGROUND OF THE INVENTION

1. Field of the Invention

The present invention relates to a method for making a dual-color melamine container, more particularly a method for making a dual-color melamine container, which uses two moulds, and two injection molding machines such that one side of the container can be dual-color, and that a pattern-attaching step can be incorporated into the present method to form patterns on both sides of the container, and the process of the present method is smooth and uninterrupted.

2. Brief Description of the Prior Art

Melamine is often used as a material in manufacturing house containers such as bowls, and plates. Such melamine containers are usually manufactured by means of injection molding. Earlier melamine containers were single color after molding therefore they look relatively monotonous. In order to make melamine containers more attractive and fancy, a pattern attaching process is applied so that patterns, drawings or characters are attached to the surfaces of the melamine containers.

Patterns are attached to melamine containers directly with a pattern attaching machine while the containers are still supported on the injection molding machine after the molding process; removal of one of two mould parts of the mould from the other uncovers one side of the melamine containers for allowing patterns to be attached to the melamine containers. However, patterns can be attached to only one side of a melamine container with this method because only one of the mold parts can be removed to uncover one side of the container, and the other side of the container is still joined to the other mold part on the course of pattern attaching.

Consequently, only melamine containers having patterns on single side are available, which are not attractive and fancy enough.

In order to provide more attractive and fancy melamine containers, the above method for making melamine containers is improved by means of using two female molds and one male mold together with an injection molding machine or using two male molds and one female mold together with an injection molding machine. Referring to FIGS. 1, 2, and 3, which illustrates a method for making melamine containers, in which a first and a second female molds, and one male mold are used; this method includes the following steps: (1) making a first part of a melamine container with the injection molding machine, the male mold and the first female mold; (2) moving the second female mold, and repositioning the first container part so that the first container part is disposed between the second female mold and the male mold; the second female mold is made in such that a thickness of the space between the male mold and the second female mold is substantially equal to that of the first container part; (3) injecting melamine materials into between the male mold and the second female mold to form a second part of the container over the first container part. Thus, the container includes the first part on an inner side, and the second part on the outer side, which is substantially as thick as the first part. And, the first and the second container parts can be made different colors easily because they are formed in separate injection molding processes. Melamine materials made in this method are more attractive and fancy because they are dual-color.

However, this method is found to have disadvantages as followings:

1. The first and the second female molds are used in turn. In other words, the first female mold is not used when the second container part is being formed over the first container part and vice versa. Consequently, this method is not very efficient.

2. Because the first and the second female molds are used in turn, they are likely to become cool while they are not in used for the injection molding. Consequently, the female molds have to be preheated each time it is their turn otherwise the injection molding cannot be properly performed.

3. Patterns still can be attached to only one side of a melamine container while the melamine container is made with, and supported on, the injection molding machine.

4. Although the dual-color melamine container made with this method is more attractive and fancy than a single-color one, each of the container parts is still single-color.

### SUMMARY OF THE INVENTION

It is a main object of the present invention to provide a method for making a melamine container, which uses two molds, and two injection molding machines so that different-color inner and outer parts of melamine containers can be made in separate processes and in a smooth and uninterrupted way.

It is a second object of the present invention to provide a relatively efficient method for making a melamine container, which has different-color inner and outer parts with patterns attached thereto.

It is a third object of the present invention to provide a method for making a melamine container, which also allows one of two parts of the melamine container to be made dual-color, and have patterns formed with injection molding alone.

It is a fourth object of the present invention to provide a method for making a melamine container, which allows a pattern-attaching step to be incorporated into it so that patterns can be formed on both sides of the container.

The first mold is provided for making an inner part of container with, and has a male part, which is formed with several projecting patterns thereon so that the inner part of container is formed with holes having patterns. The inner part of container is repositioned in the second mold, and a different-color melamine material is injected into the second mold to form an outer part of container over the inner part; thus, the inner part can be made dual-color with injection the molding process alone.

### BRIEF DESCRIPTION OF THE DRAWINGS

The present invention will be better understood by reference to the accompanying drawings, wherein

FIG. 1 is a view illustrating a first step of a conventional method for making a dual-color melamine container with two female mould parts, and one male mould part,

FIG. 2 is a view illustrating a second step of the conventional method for making a dual-color melamine container,

FIG. 3 is a view illustrating a third step of the conventional method for making a dual-color melamine container,

FIG. 4 is a flow chart of the method for making a dual-color melamine container according to the present invention,

FIG. 5 is a perspective view of an inner part of a melamine container made with the method of the present invention,

FIG. 6 is a perspective view of a dual-color melamine container made with the method of the present invention,

FIG. 7 is a cross-sectional view of a dual-color melamine container made with the method of the present invention,

FIG. 8 is a cross-sectional view of an inner part of a melamine container with the annular section thereof patterned with shaped through holes according to the method of the present invention,

FIG. 9 is a perspective view of an inner part of a melamine container with patterns attached thereto according to the present invention,

FIG. 10 is a perspective view of the melamine container with an inner part being patterned with different-color melamine materials according to the method of the present invention,

FIG. 11 is a cross-sectional view of the melamine container in FIG. 10,

FIG. 12 is a perspective view of a melamine container having an inner part made dual-color according to the method of the present invention; and,

FIG. 13 is a cross-sectional view of the melamine container in FIG. 12.

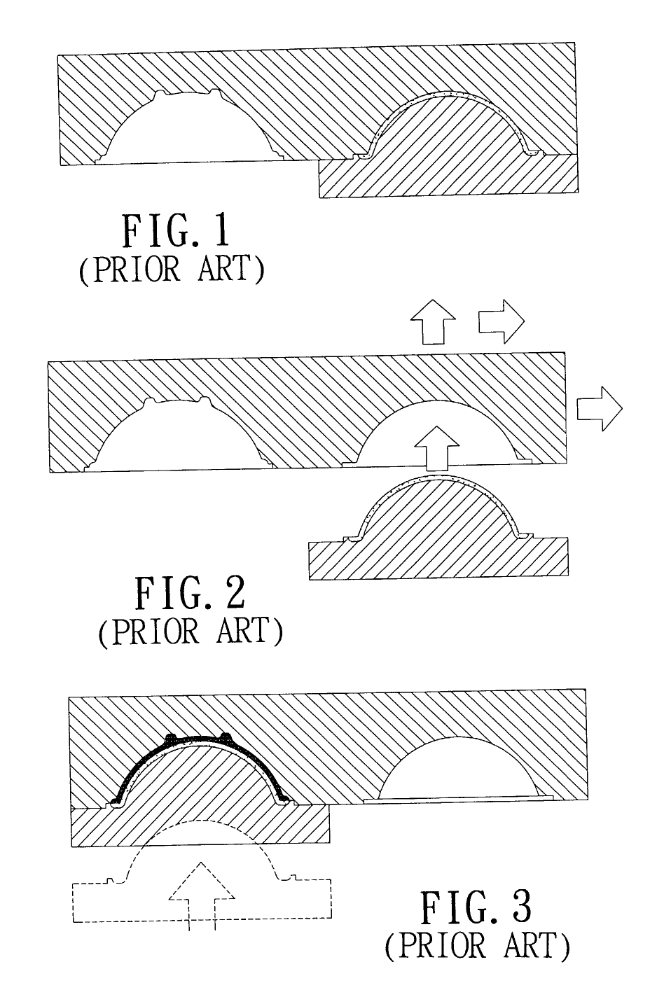

### DETAILED DESCRIPTION OF THE PREFERRED EMBODIMENTS

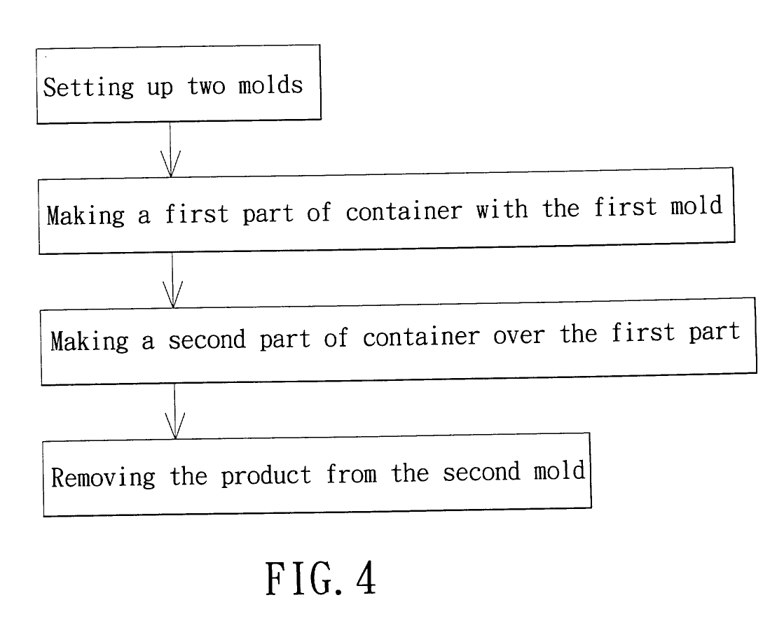

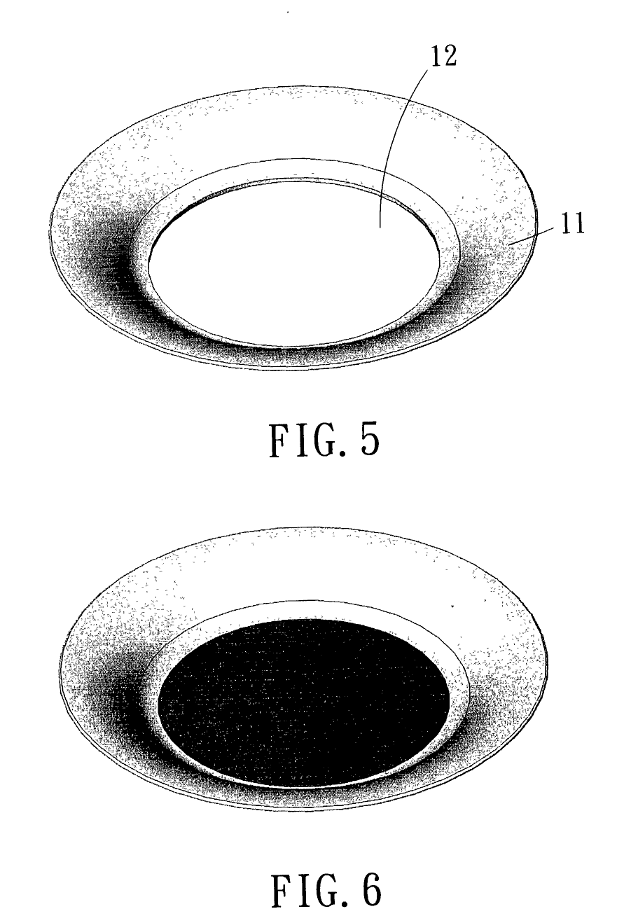

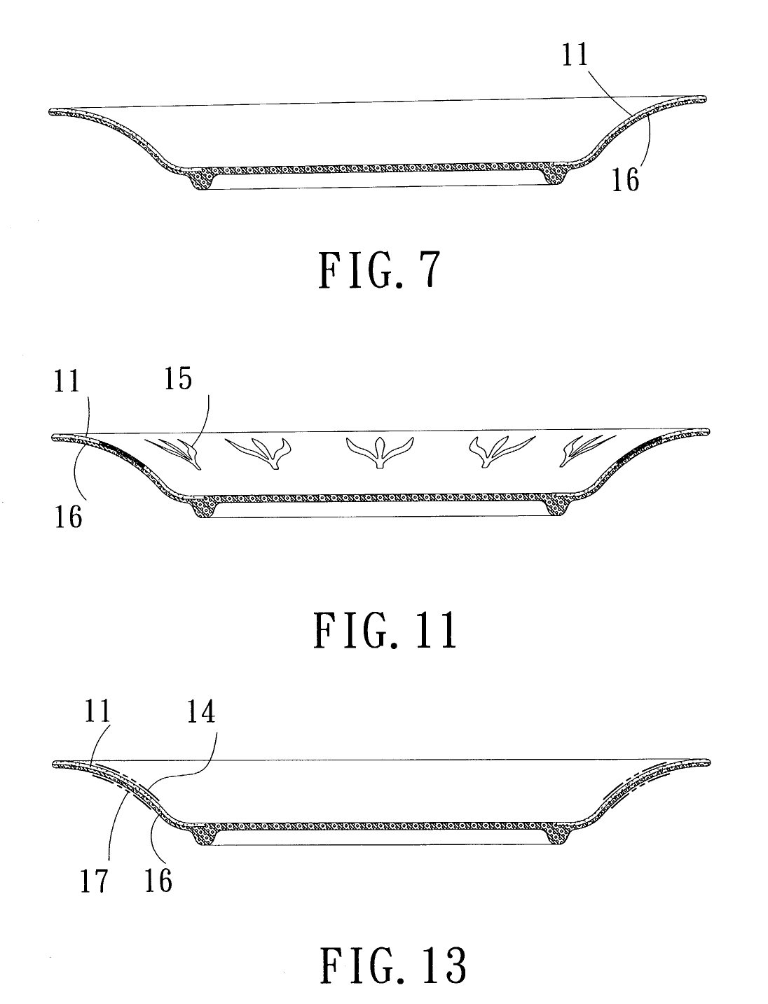

Referring to FIGS. 4, 8, 9, 10, and 12, a method for making a dual-color melamine container according to the present invention includes steps as followings:

(1) Setting up, including the following actions: setting up a first mold, and a second mold on respective injection molding machines; each of the molds including a male part, and a female part; the male part of the first mold being formed with several protrusions thereon; the second mold being made in such a manner that an inner space thereof is substantially twice as thick as an inner space of the first mold. The male part of the first mold is made such that the protrusions thereof can include a central round protrusion, and several projecting patterns equidistantly arranged around the center of the male part; the male part of the first mold can be made to only have the central round protrusion or the equidistantly arranged projecting patterns.

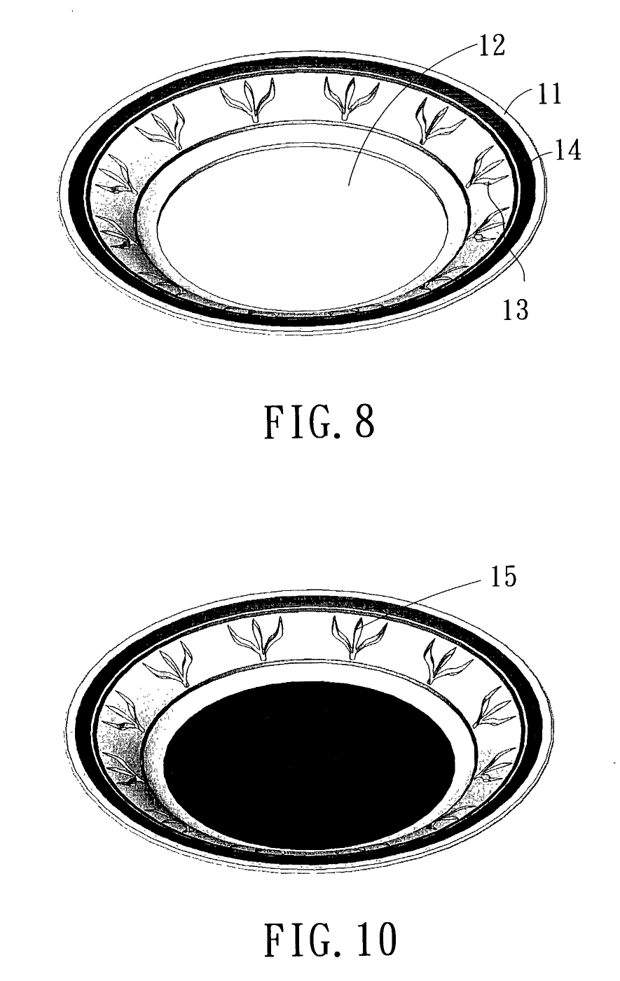

(2) Making a first part of a container, including the following actions: making a first part of a container by means of injecting a first melamine material into the first mold so that the first container part is formed with holes 12, and 13 corresponding to the protrusions of the male part of the first mold as shown in FIG. 8.

(3) Making a second part of container; including the following actions: repositioning the first container part in the second mold, and injecting a second melamine material into the second mold for a second container part to be formed over the first container part so that a melamine container is made, which consists of the first and the second parts; the first and the second melamine materials being different colors; the second melamine material will be also injected into the holes 12, and 13 of the first container part for them to be filled. Thus, a dual-color melamine container as shown in FIG. 10, is formed, which has a dual-color inner side because the holes 13 (FIG. 8) are filled with the second melamine material to become patterns 15.

(4) Removing the melamine container product from the second mold.

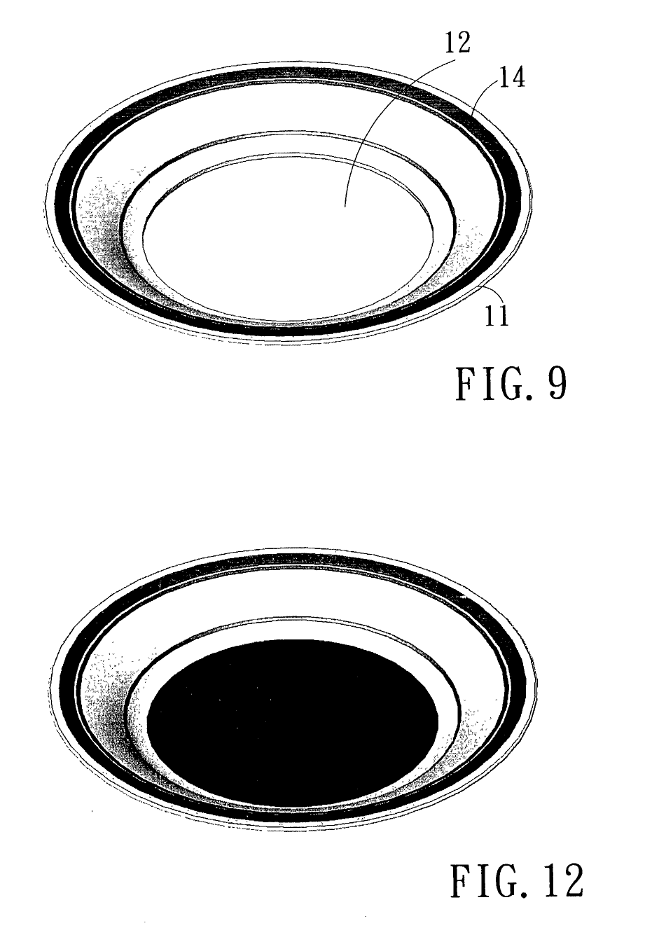

Referring to FIGS. 9, and 12, if the male part of the first mold only has a central protrusion, the first container part will only has a central round hole 12, and the container has a dual-color inner side because the hole 12 is filled with the second melamine material.

If the male part of the first mold only has the equidistantly arranged projecting patterns, the container will has a dual-color inner side with patterns 15 because the holes 13 are filled with the second melamine material.

Furthermore, after the second step is finished, a first additional step is provided, whereby the male part of the first mold is separated from the first container part to uncover an inner side 11 of the first container part, and patterns 14 (FIGS. 8, and 9) are attached to the inner side 11 of the first container part with a pattern attaching machine. And, after the third step is finished, a second additional step is provided, whereby the female part of the second mold is separated from the container to uncover an outer side 16 of the container, and patterns 17 as shown in FIG. 13 are attached to the inner side 16 of the container with a pattern attaching machine. Thus, the dual-color melamine container is made to have patterns on both sides.

From the above description, it can be easily understood that the method for making a dual-color melamine container according to the present invention has advantages as followings:

It is a main object of the present invention to provide a method for making a melamine container, which uses two molds, and two injection molding machines so that different-color inner and outer parts of melamine containers can be made in separate processes and in a smooth and uninterrupted way.

1. Because two molds and two injection molding machines are used, a first part of another container can be made with the first mold while the second mold is used to make a second part of an earlier. Therefore, the injection molding processes of each of the molds can be performed one after another nearly without any waiting. In other words, the present method is very efficient.

2. While the second mold is used for making a second part of a container, the first mold is also used for making a first part of another container so the molds do not have a standby period, which would cause them to become cool, and need to be preheated before each injection molding process. Therefore, time and energy are saved.

3. The first part of the container product, i.e. the inner part, is made dual-color because it is filled with some of the melamine material injected into the second mold in the molding process of the second part of container. Therefore, the melamine container is relatively attractive and fancy as compared with the conventional dual-color one, each of two sides of which is single-color.

4. When the male part of the first mold is formed with projecting patterns around the center for an inner part of container to have corresponding pattern holes, the inner side of a container product can be formed with patterns by injection molding alone.

5. Using two molds and two injection molding machines, the present method allows patterns to be attached to two sides of container products on the same location easily with pattern attaching machines while the products are still supported on the molding machines. Therefore, a lot of labor is saved, and products can be made with uniform quality.

What is claims is:

1. A method for making a dual-color melamine container, comprising
a first step: setting up a first mold, and a second mold on respective injection molding machines, each of the molds including a male part, and a female part; the male part of the first mold being formed with a plurality of protrusions thereon; an inner space of the second mold being thicker than an inner space of the first mold;
a second step: making a first part of a container by means of injecting a first melamine material into the first mold so that the first container part is formed with holes corresponding to the protrusions of the male part of the first mold;
a third step: repositioning the first container part in the second mold, and injecting a second melamine material into the second mold for a second container part to be formed over the first container part so that a melamine container is made; the second melamine material being also injected into the holes of the first container part for the holes to be filled with it; the first and the second melamine materials being different colors; and,
a fourth step: removing the melamine container product from the second mold.

2. The method for making a dual-color melamine container as claim in claim 1, wherein a first additional step is provided between the second and the third steps, which is separating the first male part from the first container part, and attaching patterns to an inner side of the first container part with a pattern attaching machine, while a second additional step is provided between the third and the fourth steps, which is separating the second female part from the melamine container, and attaching patterns to an outer side of the second container part a pattern attaching machine.

3. The method for making a dual-color melamine container as claim in claim 1, wherein the second mold is made such that a thickness of the second container part is substantially equal to that of the first container part.

4. The method for making a dual-color melamine container as claim in claim 1, wherein the protrusions of the first male part are made such that the holes includes a round hole on a center of the first container part, and a plurality of pattern-forming holes around the central round hole.
